(19) United States
(12) Patent Application Publication
(10) Pub. No.: US 2026/0068871 A1
(43) Pub. Date: Mar. 12, 2026

(54) Animal Call Device

(71) Applicant: Mark A. Buzzell, Carmel, ME (US)

(72) Inventor: Mark A. Buzzell, Carmel, ME (US)

(21) Appl. No.: 19/081,542

(22) Filed: Mar. 17, 2025

Related U.S. Application Data
(60) Provisional application No. 63/691,869, filed on Sep. 6, 2024.

(51) Int. Cl. A01M 31/00

(52) U.S. Cl. CPC A01M 31/004

(57) ABSTRACT

The present invention discloses an animal call device, which operates by a user blowing into the mouthpiece of the call body, such that the flow of air causes an internal reed to vibrate, with the air flowing out through a resonator, creating a sound that emulates the calls and grunts of a deer; with the present invention incorporating a moveable slide that presses against and dynamically alters the vibratory properties of the reed, thereby changing the sounds that are created by the animal call device.

### CROSS REFERENCE TO RELATED APPLICATION

This application claims the benefit of the provisional patent application, U.S. Ser. No. 63/691,869, filed Sep. 6, 2024, entitled “Deer Call” (Mark A. Buzzell), and currently pending, which is hereby incorporated by reference.

### BACKGROUND OF THE INVENTION

This present invention relates to game calls for attracting animals, and in particular whitetail deer and other types of deer, by producing sounds that are similar to sounds made by deer.

Animal calls have been designed and manufactured over the years to call game animals and game birds, and are used by hunters as well as photographers. Though some animal calls involve electronic sound production, traditional animal calls use air provided by the user blowing into the animal call, causing a reed to vibrate to produce a sound. Improvements in the art have been developed to make the animal calls easier to use and produce more accurate sounds.

Most traditional animal calls are configured to produce a single sound. Some may produce several pre-determined sounds. However, the experienced user may wish to produce variable sounds to attract the target animal, and be able to produce variable sounds in quick succession. Traditional animal calls do not afford this opportunity.

What is needed, then, is an animal call that is operated by a user blowing air into the call, wherein the call is capable of producing variable sounds, in rapid succession.

It is therefore an objective of the present invention to provide an improved animal call that is capable of producing variable sounds.

It is another objective of the present invention to provide an improved animal call that is capable of producing variable sounds in rapid succession.

It is yet another objective of the present invention to provide an improved animal call that produces sounds made by deer, and in particular whitetail deer.

It is yet another objective of the present invention to provide an improved animal call that produces sounds made by deer of varying ages and sexes.

It is yet another objective of the present invention to provide an improved animal call that is simple to assemble and disassemble for easy cleaning.

It is yet another objective of the present invention to provide an improved animal call that is comfortable to grip and use.

It is yet another objective of the present invention to provide an improved animal call that is aesthetically pleasing in design and appearance.

Various other objectives and advantages will become apparent with the description of the invention.

### SUMMARY OF THE INVENTION

The animal call of the present invention comprises the following primary elements: a call body, which is substantially elongate with a hollow interior; a tone chamber, which is substantially elongate with a hollow interior; and a resonator, which is substantially elongate with a hollow interior.

One end of the tone chamber fits into the call body, and the resonator fits onto the opposite end of the tone chamber. The hollow interiors of the call body, the tone chamber, and the resonator are in alignment with each other.

The call body is further comprised of a mouthpiece formed into one end of the call body, with the call body having an insertion end located opposite the mouthpiece end. The call body may be shaped between the mouthpiece and the insertion end to provide for a comfortable grip by the user. The tone chamber is inserted into the hollow interior of the call body through the insertion end of the call body.

The tone chamber further comprises a tone board, a slide, a wedge, and a thumb stud. The hollow interior of the tone chamber accommodates the tone board. A slot formed into the top of the tone chamber, running along the longitudinal axis of the tone chamber, accommodates the slide.

The tone board is elongate and is configured to hold a reed on its upper surface.

The reed is placed onto the upper surface of the tone board and the wedge is placed onto the upper surface of the reed, then the entire assembly is inserted into the tone chamber where it is retained snugly therein by frictional forces.

The slide is configured to move within and along the slot of the tone chamber, with the distal end of the slide configured to press against the reed. Movement of the slide within and along the slot causes the distal end of the slide to press against different portions of the reed, thereby changing the vibratory characteristics of the reed and thus altering the sound created by the reed when air passes over it. The proximate end of the slide is oriented upwardly and incorporates the thumb stud thereon to facilitate movement of the slide within the slot.

When the tone chamber is inserted into the call body, portions of the tone board and reed are located within the hollow interior of the call body.

The resonator is configured to be inserted onto the end of the tone chamber opposite the end of the tone chamber that is inserted into the call body. The resonator enhances the sounds made by the reed.

A lanyard may be attached to the call body.

Different materials may be used in the construction of the device, selected for sound quality and aesthetic value. Wood, such as maple, spruce, and other woods are contemplated to be used in the construction of the device. Molded plastics or acrylics may also be used. The entire device may be finished with one or more coats of a lacquer, paint, or other preservatives to protect the materials from which it is made, as well as to enhance the aesthetic value of the device.

The animal call device is used by being held by a user, who blows into the mouthpiece of the call body, thereby causing air to pass over the reed, making the reed vibrate and create a sound. The user may change the position of the slider, thereby changing the sound that is created. Dynamically moving the slider while simultaneously blowing into the device creates continuous variable sounds. These sounds may emulate the calls and grunts of deer, as well as the bleats of does.

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims.

### DESCRIPTION OF THE DRAWINGS

FIG. 1 depicts a top perspective view of the call body, the tone chamber, and the resonator, with the tone chamber inserted into the call body and the resonator inserted onto the tone chamber.

FIG. 2 depicts a side perspective view of the call body of one embodiment of the present invention.

FIG. 3 depicts a side perspective view of the tone chamber with the tone board, the reed, and the slide. The tone board is inserted into the hollow interior of the tone chamber, the reed is installed on the top surface of the tone board, and the slide is pressed against the top surface of the reed.

FIG. 4 depicts a side perspective view of the resonator.

FIG. 5 depicts an exploded perspective side view of the call body, tone chamber, and resonator, with arrows indicating how these components fit into each other.

FIG. 6 depicts an end perspective view of the call body, and the interior space for insertion of tone chamber.

FIG. 7 depicts an end perspective view of the call body and the mouthpiece.

FIG. 8 depicts a top perspective view of the tone chamber with the tone board, the reed, and the slide. The “O”ring is shown, with the slide passing under the “O”ring.

FIG. 9 depicts a top perspective view of the tone chamber with resonator

FIG. 10 depicts an end perspective view of the tone chamber with the tone board, the reed, and the slide.

FIG. 11 depicts a partial top perspective view of the tone chamber with the slide and the reed.

FIG. 12 depicts an end perspective view of the tone chamber from its insertion end.

FIG. 13 depicts an end perspective view of the tone chamber from its resonator end.

FIG. 14 depicts a top perspective view of the tone board, with the wedge next to the tone board.

FIG. 15 depicts a perspective side view of the tone board.

FIG. 16 depicts a perspective bottom view of the tone board.

FIG. 17 depicts a top view of the reed.

FIG. 18 depicts a perspective top view of the wedge.

FIG. 19 depicts a perspective bottom view of the thumb stud.

### DETAILED DESCRIPTION OF THE INVENTION

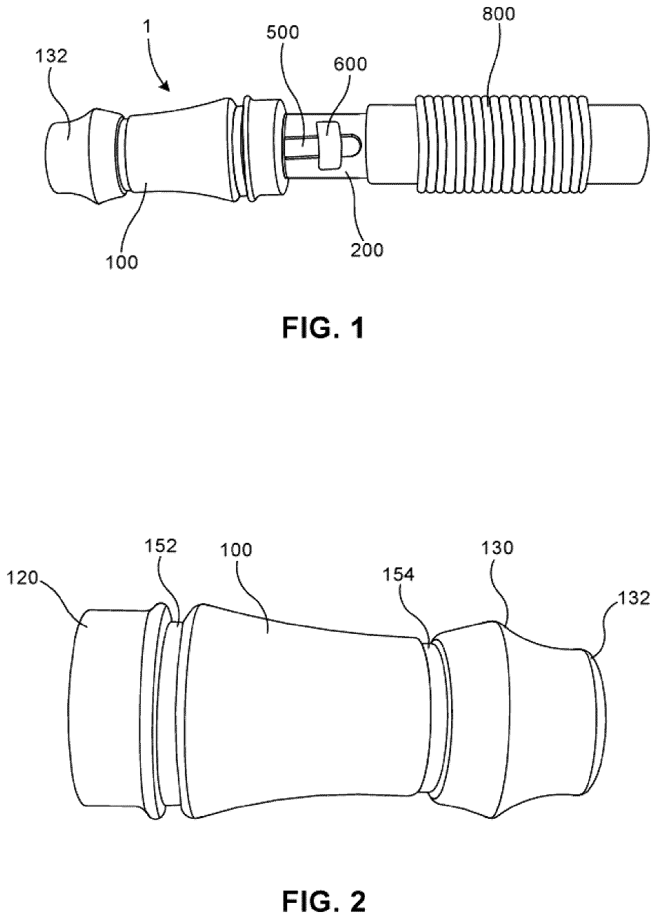

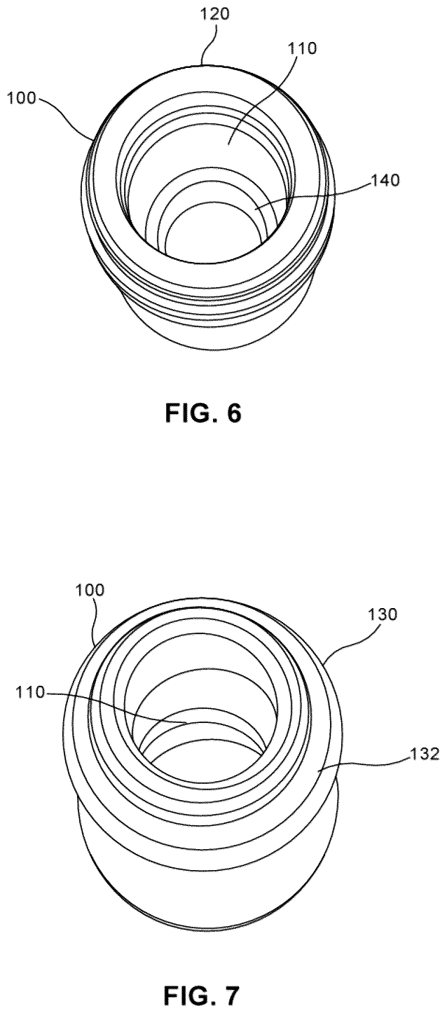

One embodiment of the animal calling device 1 of the present invention comprises a call body 100 and a tone chamber 200. See FIG. 1. The call body 100 is an elongate structure having a substantially cylindrical shape and a hollow interior space 110. See FIG. 2. One end of the call body 100 is identified as the insertion end 120 of the call body 100. See FIG. 6. The other end of the call body 100, located opposite the insertion end 120, is identified as the second end 130 of the call body 100. See FIG. 7. The call body 100 may be of any practical length; in the preferred embodiments it is between 3 inches to 3¼ inches long. The call body 100 has a rounded, shaped circumference to provide the user a better grip on the device 1 while using it. The call body 100 may have a width of about 1⅜ inches at the insertion end 120, and the width tapers down to about 1 inch at the second end 130. There may be two grooves 152,154 cut into the call body 100 to accept a lanyard for carrying the device 1.

The call body 100 of the device 1 may be made of any suitable material, such as wood, molded plastics, or acrylics. When the call body 100 is made of wood, it may be finished with one or more coats of a lacquer, paint, or other preservatives.

The hollow interior 110 of the call body 100 may be formed as follows: starting at the insertion end 120 of the call body 100, a hole is drilled into the call body 100 along the central longitudinal axis of the call body 100, to a depth of less than one half of the length of the call body 100. Preferably, the depth is about ¾ inch. Then the call body 100 is drilled the rest of the way through the call body 100 with a smaller drill bit than that which was used to form the initial hole. Preferably, the larger drill bit is ⅞ inch and the smaller drill bit is ⅝ inch, but other sizes may be used. The shoulder 140 that is created within the hollow interior 110 of the call body 100 by the size change of the drill bits is sanded to a smooth transition from the larger hole to the smaller hole. Thus, the hollow interior 110 at the insertion end 120 of the call body 100 may have an inside diameter of about ⅞ inch, and the hollow interior 110 at the second end 130 of the call body 100 may have an inside diameter of about ⅝ inch.

In the preferred embodiment, the call body 100 has mouthpiece 132 formed into the second end 130 of the call body 100. See FIG. 7. The mouthpiece 132 is shaped to provide the user of the device 1 with a comfortable interface with the device 1. The user places his or her mouth onto the mouthpiece 132 and blows air through the mouthpiece 132.

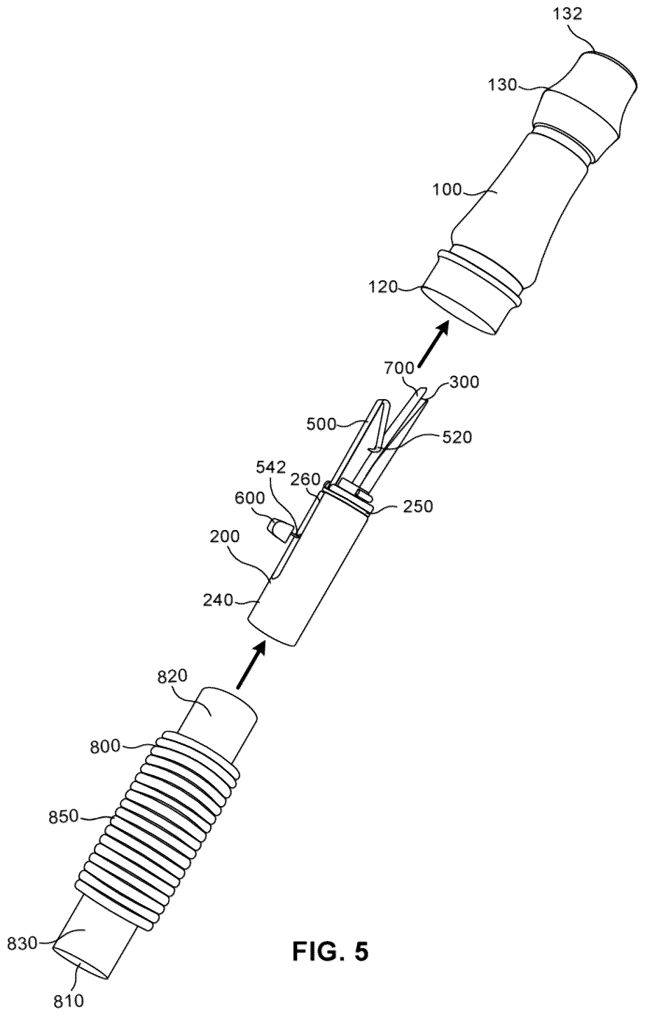

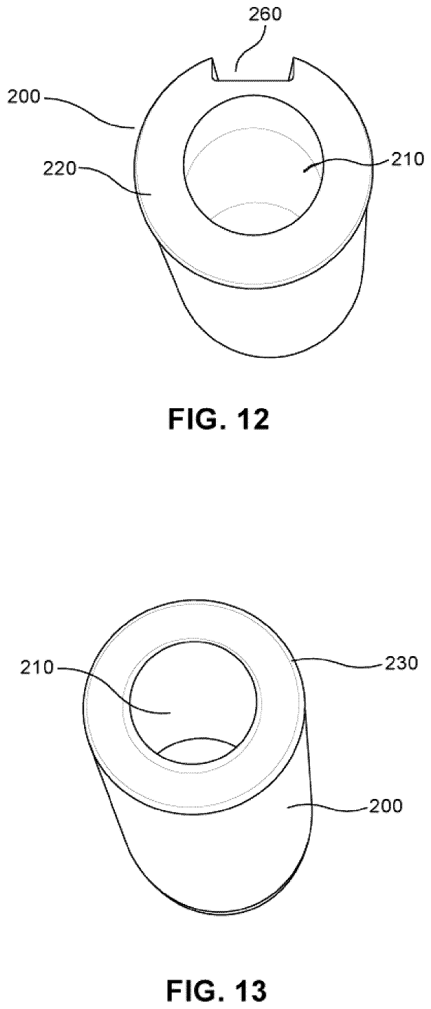

The tone chamber 200 of the device 1 is an elongate structure having an insertion end 220, see FIG. 12, a resonator end 230 located opposite the insertion end 220, see FIG. 13, and a hollow interior 210. The insertion end 220 of the tone chamber 200 is configured to fit into the insertion end 120 of the call body 100, such that when the tone chamber 200 is inserted into the insertion end 120 of the call body 100 a portion of the tone chamber 200 is located within the hollow interior 110 of the call body 100, with the hollow interiors 110,210 of the call body 100 and the tone chamber 200 being in alignment with each other. See FIG. 5. Insertion of the insertion end 220 of the tone chamber 200 into the hollow interior 110 of the call body 100 is limited by the interior shoulder 140 of the call body 100.

The tone chamber 200 may be of any practical dimension. In the preferred embodiment it is about 2½ inches long, with an outside diameter of about ⅞ inch (in general, the outside diameter of the tone chamber 200 should be just a bit smaller than the inside diameter of the call body 100 at the insertion end 120 of the call body 100, to allow for insertion of the insertion end 220 of the tone chamber 200 into the hollow interior 110 of the call body 100 through the insertion end 120 of the call body 100, where it will be retained by frictional forces). The hollow interior 210 of the tone chamber 200 has an inside diameter of about 1/2 inch. The tone chamber 200 may be made of any suitable material, such as wood, molded plastics, or acrylics.

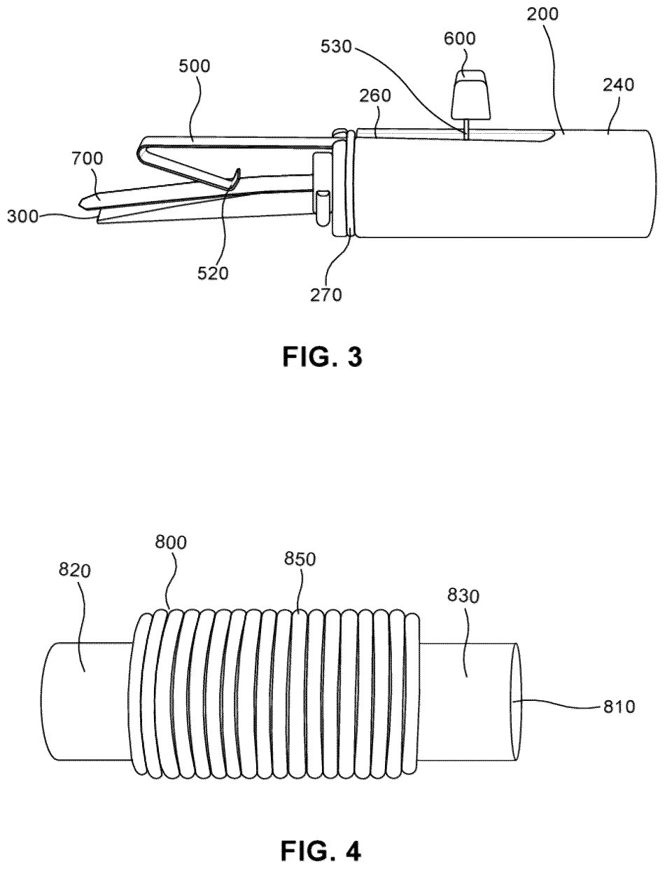

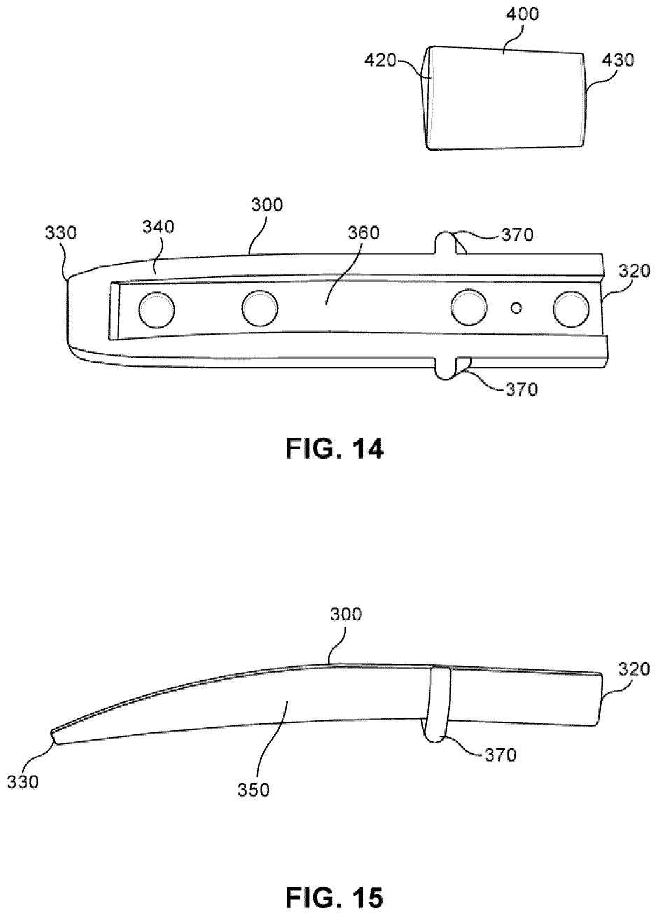

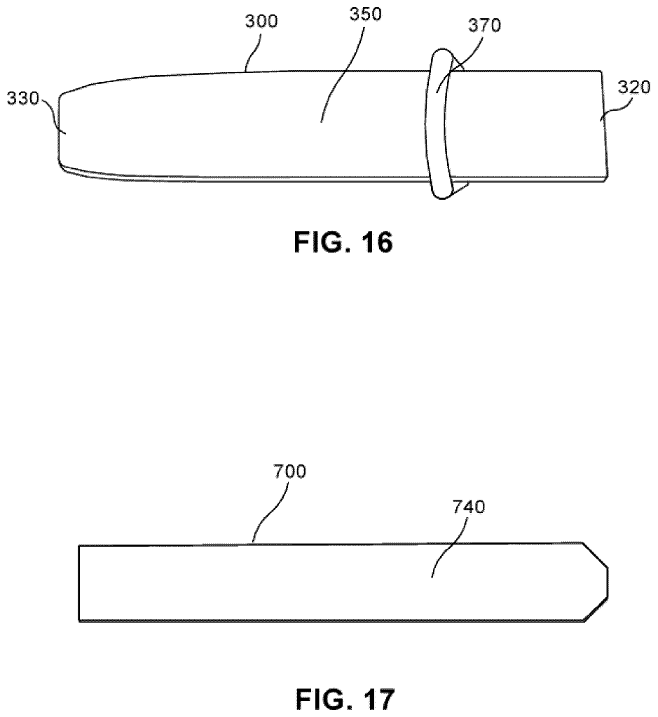

Located within the tone chamber 200 are a tone board 300, a reed 700, and a wedge 400. See FIG. 3. The tone board 300 is elongate and has a distal end 320, a proximate end 330, an upper surface 340, and a lower surface 350. See FIG. 14. A channel 360 is formed into the upper surface 340 of the tone board 300 and is dimensioned to accommodate the elongate reed 700. On the lower surface 350 of the tone board 300 is a stop shoulder 370, which protrudes downward. In one embodiment the tone board 300 is a half round member about 2 9/16 inches long, ½ inch wide, and ¼ inch thick, with the channel 360 being about ¼ inch wide. The tone board 300 may be cut at an angle, starting about 1 inch from the proximate end 330, with the cut done at a slope so the distal end 320 is only about 3/32 inch thick. See FIG. 15. The stop shoulder 370 is located about ¾ inch from the proximate end 330 of the tone board 300 and is about ⅛ inch wide. See FIG. 16. The tone board 300 may be made of any suitable material, such as wood, molded plastics, or acrylics.

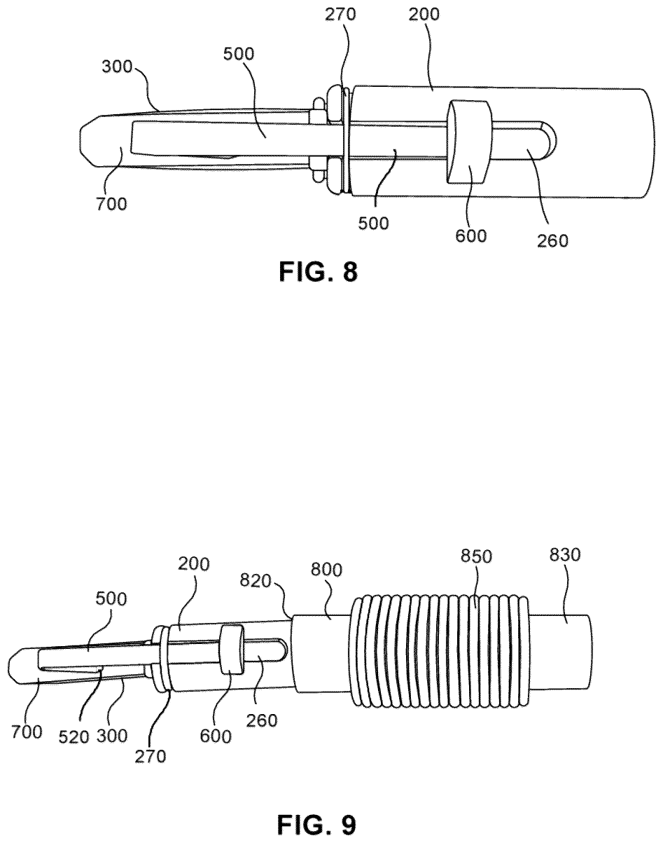

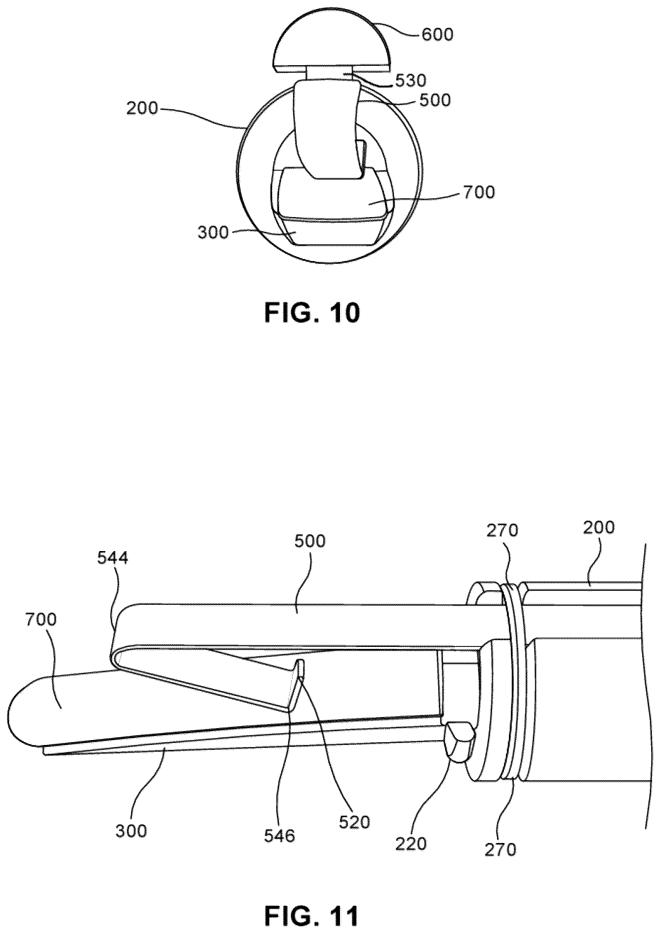

The proximate end 330 of the tone board 300 is configured to be inserted into the insertion end 120 of the call body 100 such that when the reed 700 is placed onto the upper surface 340 of the tone board 300 and the proximate end 330 of the tone board 300 is inserted into the insertion end 120 of the call body 100 a portion of the tone board 300 adjacent to the proximate end 330 of the tone board 300 is located within the hollow interior 110 of the call body 100 and a portion of the reed 700 is located within the hollow interior 110 of the call body 100. See FIG. 8. The distal end 320 of the tone board 300 is configured to be inserted into the insertion end 220 of the tone chamber 200 such that when the reed 700 is placed onto the upper surface 340 of the tone board 300 and the distal end 320 of the tone board 300 is inserted into the insertion end 220 of the tone chamber 200 a portion of the tone board 300 adjacent to the distal end 320 of the tone board 300 is located within the hollow interior 210 of the tone chamber 200 and a portion of the reed 700 is located within the hollow interior 210 of the tone chamber 200. See FIG. 10. The stop shoulder 370 of the tone board 300 is configured to inhibit insertion of the distal end 320 of the tone board 300 into the hollow interior 210 of the tone chamber 200 beyond the stop shoulder 370.

The reed 700 may be of any suitable length and width. In one embodiment, the reed 700 is 0.010 inch thick, 13/16 inches long, and 7/16 inch wide, with one end having the two corners cut off at 45-degree angles, leaving the piece between the cuts to be a flat 5/32 inch assembly. See FIG. 17. Other configurations of the reed 700 are also contemplated.

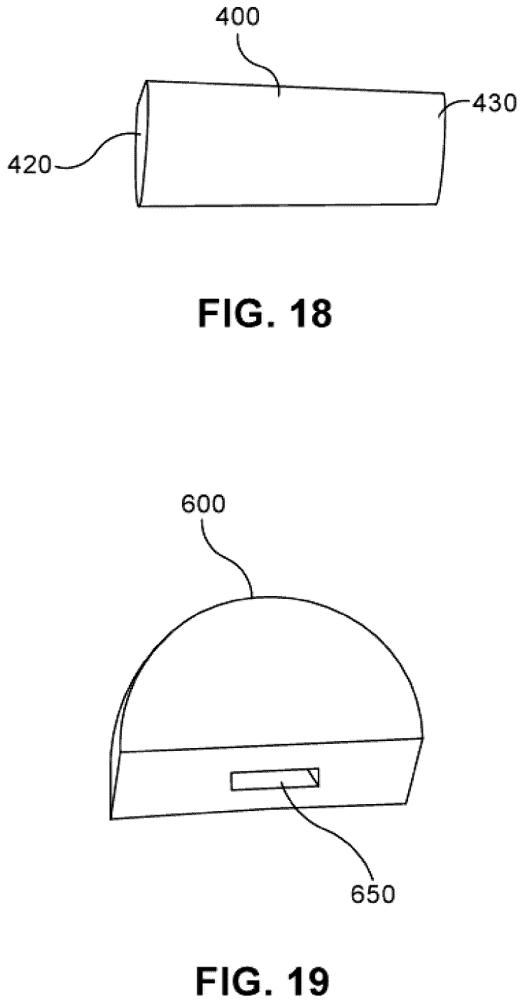

The wedge 400 is a half round member having a wide end 420 and a tapered end 430. See FIG. 18. The wedge 400 may be about ¾ inch long, ½ inch wide, and ¼ inch thick at the wide end 420, tapering to 7/32 inch thick at the tapered end 430. Other suitable dimensions of the wedge 400 are also contemplated. The wedge 400 is placed onto the upper surface 740 of the reed 700 and then the distal end 320 of the tone board 300 is placed into the hollow interior 210 of the tone chamber 200. The wedge 400 is used to keep the reed 700 in place and to lock the tone board 300 in place within the tone chamber 200.

Integrated with the tone chamber 200 is a slide 500. The slide 500 is elongate and has a distal end 520, a proximate end 530 located opposite the distal end 520, and a proximate portion 532 located adjacent to the proximate end 530. See FIG. 11. The slide may be made of any substantially rigid material, such as metal, a metal alloy, composites, and the like. In the preferred embodiment the slide 500 is made of brass. The slide 500 is dimensioned as suitable. In one embodiment, the slide 500 is approximately ¼ inch wide by 3 15/16 inches long and 0.025 inches thick, with rounded ends. The slide 500 further is bent several times, such that the proximate end 530 of the slide 500 is located proximate to the top surface 240 of the tone chamber 200 and the distal end 520 of the slide 500 is located on the top surface 740 of the reed 700 when the reed 700 is placed onto the tone board 300 and the tone board 300 is inserted into the tone chamber 200.

In the preferred embodiment, the tone chamber 200 comprises a slot 260. The slot 260 is formed into the top surface 240 of the tone chamber 200, running along the longitudinal axis of the tone chamber 200. See FIG. 8. The slot 260 of the tone chamber 200 is configured to accommodate the proximate portion 532 of the slide 500 and the proximate portion 532 of the slide 500 is configured to move within and along the slot 260 of the tone chamber 200. The slot 260 of the tone chamber 200 is not in communication with the hollow interior 210 of the tone chamber 200.

There may be a circumferential groove 250 cut around the tone chamber 200 proximate to the insertion end 220 of the tone chamber 200. The groove 250 intersects the slot 260 of the tone chamber 200. The groove 250 is located about 3/16 inch from the insertion end 220 of the tone chamber 200 and is about 3/32 inch deep and 1/16 wide, sized to accommodate an “O” ring 270, preferably a #14 size “O” ring 270. The “O” ring 270 is used to hold the proximate portion 532 of the slide 500 in place within the slot 260 of the tone chamber 200. The “O” ring 270 keeps airflow from escaping the device 1 through the slot 260 and provides resistance to the movement of the slide 500.

Movement of the slide 500 within and along the slot 260 of the tone chamber 200 causes the distal end 520 of the slide 500 to press against different portions of the upper surface 740 of the reed 700, thereby changing the vibratory characteristics of the reed 700 and altering the sounds that can be created by the reed 700 when air passes over the reed 700.

In the preferred embodiment, the slide 500 has three bends. See FIG. 11. The first bend 542 of the slide 500 is located adjacent to the proximate end 530 of the slide 500 and is bent upwards substantially 90 degrees. The portion of the slide 500 between the first bend 542 of the slide 500 and the proximate end 530 of the slide 500 is relatively short, about 5/16 inch long. The second bend 544 of the slide 500 is located between the first bend 542 of the slide 500 and the distal end 520 of the slide 500, approximately 2 9/16 inches from the first bend 542 of the slide 500, and is bent downwards from the proximate portion 532 of the slide 500, forming an acute angle relative to the proximate portion 532 of the slide 500. The angle may be about 52 degrees. The third bend 546 of the slide 500 is located between the second bend 544 of the slide 500 and the distal end 520 of the slide 500 proximate to the distal end 520 of the slide 500, and is bent upwards substantially 90 degrees. The third bend 546 of the slide 500 is configured to press against the upper surface 740 of the reed 700. The portion of the slide 500 between the third bend 546 of the slide 500 and the distal end 520 of the slide 500 is relatively short, about ⅛ inch long.

A thumb stud 600 having a slot 650 formed into its lower portion may be used. See FIG. 19. The thumb stud 600 is configured to be placed onto the proximate end 530 of the slide, with the proximate end 530 of the slide being inserted into the slot 650 of the thumb stud 600. The thumb stud 600 is a small half-round member and is glued onto the proximate end 530 of the slide 500 to allow ease of use when moving the slide 500. The thumb stud 600 may be about ⅝ inch wide at the bottom, about ⅜ inch tall in the center, and about 5/16 inch thick. The slot 650 of the thumb stud 600 may be about 5/16 inch long by 3/32 inch wide and 5/32 inch deep. Movement of the thumb stud 600 back and forth in directions parallel to the longitudinal axis of the tone chamber 200 causes the proximate portion 532 of the slide 500 to move back and forth within the slot 260 of the tone chamber 200, which causes the distal end 520 of the slide 500 to move back and forth along the upper surface 740 of the reed 700.

The animal call device 1 of the present invention may also comprise a resonator 800. See FIG. 4. The resonator 800 is placed onto the resonator end 230 of the tone chamber 200. See FIG. 9. The resonator 800 may be any known device to augment the sound from the reed 700. The resonator 800 is substantially elongate and has an insertion end 820, a distal end 830 located opposite the insertion end 820, and a hollow interior 810. The insertion end 820 of the resonator 800 is configured to fit onto the resonator end 230 of the tone chamber 200 such that when the insertion end 820 of the resonator is fit onto the resonator end 230 of the tone chamber 200 a portion of the tone chamber 200 is located within the hollow interior 810 of the resonator 800. The hollow interiors 110,210,810 of the call body 100, the tone chamber 200, and the resonator 800 are configured to be in alignment with each other.

In one embodiment, the resonator 800 is a section of rubber hose, about 4 inches long. The hose/resonator 800 has an inside diameter of about ¾ inch, matching the outside diameter of the resonator end 230 of the tone chamber 200. The hose/resonator 800 should fit snugly onto the resonator end 230 of the tone chamber 200 and is retained thereon by frictional forces. The hose/resonator 800 may have a plurality of circumferential ribs 850 located between its insertion end 820 and its distal end 830, giving the hose/resonator 800 flexibility. The hose/resonator 800 may also be somewhat elastic, so that it can be stretched. By stretching and bending the hose/resonator 800, the user can alter sounds made by the animal call device 1.

Assembly of the animal call device 1 proceeds as follows: the reed 700 is placed onto the upper surface 34 of the tone board 300 within the channel 360 of the tone board 300. About ⅛ inch of the reed 700 overhangs the edge of the proximate end 330 of the tone board 300. The wedge 400 is then placed on top of the upper surface 740 of the reed 700 at the distal end 320 of the tone board 300 adjacent to the stop shoulder 370 of the tone board 300. The distal end 320 of the tone board 300 is inserted into the hollow interior 210 of the tone chamber 200 through the insertion end 220 of the tone chamber 200 until the stop shoulder 370 of the tone board 300 comes in contact with the insertion end 220 of the tone chamber 200. The wedge 400 is pushed into the tone chamber 200 to lock the reed 700 and the tone board 300 into the hollow interior 210 of the tone chamber 200. When the tone board 300 is inserted onto the hollow interior 210 of the tone chamber 200, the tone board 300 and reed 700 are aligned with the slot 260 of the tone chamber 200. The slide 500 with the thumb stud 600 is placed into the slot 260 of the tone chamber 200 with the thumb stud 600 positioned upwards. The “O” Ring 270 is then brought over the tone board 300 and the slide 500 and is inserted into the circumferential groove 250 cut into the tone chamber 200 to hold the slide 500 in place. The tone chamber 200 can now be inserted into the hollow interior 110 of the call body 100 at the insertion end 120 of the call body 100 for a secure fit. Finally, the resonator 800 (if present) is installed onto the resonator end 230 of the tone chamber 200 to enhance sounds emitted by the device 1.

With the animal call device 1 assembled, the user can mimic the sounds of a deer by blowing air through the mouthpiece 132 of the call body 100 and adjusting the slide 500 back and forth. When the slide 500 is fully extended, the device 1 makes a sound like that of a mature buck grunt, and when the slide 500 is fully retracted the device 1 makes a sound like that of a doe's bleat. Intermediate positions of the slide 500 will create sounds like various other deer.

While the preferred embodiments of the present invention have been described, modifications can be made and other embodiments may be devised without departing from the spirit of the invention.

I claim:

1. An animal calling device, comprising
a call body, said call body being substantially elongate and having an insertion end, a second end located opposite said insertion end, and a hollow interior, and
a tone chamber, said tone chamber being substantially elongate and having an insertion end, a resonator end located opposite said insertion end, and a hollow interior;
wherein the insertion end of the tone chamber is configured to fit into the insertion end of the call body, such that when the tone chamber is fit into the insertion end of the call body a first portion of the tone chamber is located within the hollow interior of the call body and the hollow interiors of the call body and the tone chamber are in alignment with each other;
whereby forcing air into the second end of the call body causes an audible sound to be emitted from the resonator end of the tone chamber.

2. The animal calling device of claim 1, wherein the call body further comprises a mouthpiece, said mouthpiece being formed into the second end of the call body;
whereby a user places the user's mouth onto the mouthpiece and blows air through the mouthpiece.

3. The animal calling device of claim 1, wherein the call body further comprises an interior shoulder, said interior shoulder being annularly disposed about an inner surface of the call body within the hollow interior of the call body, such that the hollow interior of the call body located between the interior shoulder and the insertion end of the call body has a greater inside diameter than the hollow interior of the call body located between the interior shoulder and the second end of the call body;
whereby insertion of the first portion of the tone chamber into the hollow interior of the call body is limited by the interior shoulder of the call body.

4. The animal calling device of claim 1, further comprising
a resonator, said resonator being substantially elongate and having an insertion end, a distal end located opposite said insertion end, and a hollow interior;
wherein the insertion end of the resonator is configured to fit onto the resonator end of the tone chamber such that when the insertion end of the resonator is fit onto the resonator end of the tone chamber a second portion of the tone chamber is located within the hollow interior of the resonator, and the hollow interiors of the call body, the tone chamber, and the resonator are in alignment with each other;
whereby forcing air into the second end of the call body causes an audible sound to be emitted from the distal end of the resonator.

5. The animal calling device of claim 4, wherein the resonator is flexible and extendable, such that an application of force to the resonator causes the distance between the insertion end of the resonator and the distal end of the resonator to change.

6. The animal calling device of claim 4, wherein the resonator comprises a plurality of circumferential ribs located between the insertion end of the resonator and the distal end of the resonator.

7. The animal calling device of claim 1, further comprising
a tone board, said tone board being elongate and having a proximate end, a distal end, and an upper surface, and
a reed, said reed being elongate and dimensioned to be placed onto the upper surface of the tone board;
wherein the proximate end of the tone board is configured to be inserted into the insertion end of the call body such that when the reed is placed onto the upper surface of the tone board and the proximate end of the tone board is inserted into the insertion end of the call body a portion of the tone board adjacent to the proximate end of the tone board is located within the hollow interior of the call body and a portion of the reed is located within the hollow interior of the call body; and
the distal end of the tone board is configured to be inserted into the insertion end of the tone chamber such that when the reed is placed onto the upper surface of the tone board and the distal end of the tone board is inserted into the insertion end of the tone chamber a portion of the tone board adjacent to the distal end of the tone board is located within the hollow interior of the tone chamber and a portion of the reed is located within the hollow interior of the tone chamber.

8. The animal calling device of claim 7, wherein the tone board further comprises a channel, said channel formed into the upper surface of the tone board and configured to accommodate the reed within said channel.

9. The animal calling device of claim 7, wherein the tone board further comprises a lower surface and a stop shoulder, said stop shoulder formed onto the lower surface of the tone board and configured to limit the insertion of the distal end of the tone board into the hollow interior of the tone chamber.

10. The animal calling device of claim 7, further comprising
a wedge, said wedge having a wide end and a tapered end located opposite the wide end, said wedge being configured to be placed onto the tone board with the reed located between the wedge and the tone board, and the tapered end of the wedge being configured to be inserted into the insertion end of the tone chamber, such that when the tapered end of the wedge is inserted into the insertion end of the tone chamber frictional forces retain the wedge tightly against a portion of the reed and retain a portion of the tone board securely within the tone chamber.

11. The animal calling device of claim 7, wherein the tone chamber further comprises a top surface, a slot, and a slide,
with the slot formed into the top surface of the tone chamber, running along the longitudinal axis of the tone chamber, such that the slot is not in communication with the hollow interior of the tone chamber, and
the slide having a proximate end, a proximate portion located adjacent to the proximate end, and a distal end located opposite the proximate end, with the proximate portion of the slide being configured to move within and along the slot of the tone chamber, and with the distal end of the slide configured to press against an upper surface of the reed;
whereby movement of the slide within and along the slot causes the distal end of the slide to press against different portions of the upper surface of the reed, thereby changing vibratory characteristics of the reed and altering sounds created by the reed when air passes over the reed.

12. The animal calling device of claim 11, wherein the tone chamber further comprises
a circumferential groove located proximate to the insertion end of the tone chamber, and
a flexible O-ring configured to be placed into said circumferential groove, such that the proximate portion of the slide passes between the O-ring and the tone chamber and said proximate portion of the slide is held within the slot of the tone chamber by the O-ring.

13. The animal calling device of claim 11, wherein the slide is elongate and has a first bend, a second bend, and a third bend, with the first bend of the slide being located adjacent to the proximate end of the slide and bent upwards substantially 90 degrees, the second bend of the slide being located between the first bend of the slide and the distal end of the slide and bent downwards forming an acute angle relative to the proximate portion of the slide, and the third bend of the slide being located between the second bend of the slide and the distal end of the slide proximate to the distal end of the slide and bent upwards substantially 90 degrees;
whereby the third bend of the slide is configured to press against the upper surface of the reed.

14. The animal calling device of claim 11, further comprising
a thumb stud, said thumb stub having a slot formed into a lower portion of the thumb stud,
wherein the slot of the thumb stud is configured to accommodate the proximate end of the slide and the proximate end of the slide is inserted into the slot of the thumb stud;
whereby movement of the thumb stud back and forth in directions parallel to the longitudinal axis of the tone chamber causes the proximate portion of the slide to move back and forth within the slot of the tone chamber and the distal end of the slide to move back and forth along the upper surface of the reed.

15. The animal calling device of claim 11, further comprising
a resonator, said resonator being substantially elongate and having an insertion end, a distal end located opposite said insertion end, and a hollow interior;
wherein the insertion end of the resonator is configured to fit onto the resonator end of the tone chamber such that when the insertion end of the resonator is fit onto the resonator end of the tone chamber a second portion of the tone chamber is located within the hollow interior of the resonator, and the hollow interiors of the call body, the tone chamber, and the resonator are in alignment with each other;
whereby forcing air into the second end of the call body causes the reed to vibrate, creating an audible sound that is emitted from the distal end of the resonator.

16. The animal calling device of claim 15, wherein the resonator is flexible and extendable, such that an application of force to the resonator causes the distance between the insertion end of the resonator and the distal end of the resonator to change.

17. The animal calling device of claim 15, wherein the resonator comprises a plurality of circumferential ribs located between the insertion end of the resonator and the distal end of the resonator.

18. The animal calling device of claim 15 wherein the resonator is held onto the tone chamber by frictional forces.

19. The animal calling device of claim 1 further comprising a lanyard;
wherein the call body further comprises a first circumferential groove, with the lanyard configured to be placed into the circumferential groove of the call body.

20. The animal calling device of claim 19 wherein the call body further comprises a second circumferential groove, with the lanyard configured to be placed into the second circumferential groove of the call body.
